(19) United States
(12) Patent Application Publication
(10) Pub. No.: US 2025/0335901 A1
(43) Pub. Date: Oct. 30, 2025

(54) Methods and Systems for Personalizing Secure Smart Objects

(71) Applicant: DIGISEQ LTD., London (GB)

(72) Inventors: Colin Tanner, Uxbridge (GB); Aleksei Komarov, London (GB)

(21) Appl. No.: 18/871,491

(22) PCT Filed: Dec. 29, 2022
(86) PCT No.: PCT/EP2022/088040

§ 371 Date: Dec. 4, 2024

Related U.S. Application Data
(60) Provisional application No. 63/217,310, filed on Jul. 1, 2021.

(30) Foreign Application Priority Data
Jun. 30, 2022 (WO) PCT/EP2022/068184
Dec. 29, 2022 (WO) PCT/EP2022/088040

(51) Int. Cl. G06Q 20/34; G06Q 20/10

(52) U.S. Cl. CPC G06Q 20/3552; G06Q 20/105

(57) ABSTRACT

Methods and systems provide for personalizing a secure smart object. The secure smart object, such as a wearable, which includes a chip, and a personalization application on the chip, receives a data package in a transmission from a device, such as a smart phone. Once the data package is received, and the transmission of the data page is complete, as confirmed or otherwise verified by a personalization application on the chip having executed a security check, the personalization application on the chip of the secure smart object, processes the data package to create one or more personalized application instances on the chip of the secure smart object.

### CROSS-REFERENCES TO RELATED APPLICATIONS

This application is related to and claims priority from and is a continuation in part of commonly owned PCT Application PCT/EP2022/068184, entitled: Methods and Systems for Providing Data for Consumer Provisioning, filed on Jun. 30, 2022, which is related to and claims priority from commonly owned U.S. Provisional Patent Application Ser. No. 63/217,310, entitled: Methods and Systems for Providing Data for Consumer Provisioning, filed on Jul. 1, 2021, the disclosures of both patent applications which are incorporated by reference each in its entirety herein.

### TECHNICAL FIELD

The present disclosure is directed to systems and methods for providing data for consumer provisioning.

### BACKGROUND

Personalization is one of the major cost components and logistical barriers to the mass adoption of “passive” secure smart objects, such as wearables, for example, enabled with an EMV payment account. EMV is a payment method based upon a technical standard for smart payment cards and for payment terminals and automated teller machines which can accept them. EMV originally stood for “Europay®, Mastercard®, and Visa®”, the three companies which created the standard. The need to personalize the secure smart object, wearable with the payment account during fulfillment introduces requirements on the fulfillment process, which are difficult to scale, and significantly reduce the available fulfillment channels.

Personalizing smart card applications, such as payment accounts, from consumer owned computerized devices onto secure smart objects, including wearables has not always been possible. This is due to factors such as poor consumer experiences, in part because the process is difficult to perform for those unfamiliar with undertaking it, and the failure to perform it correctly, resulting in further tasks being required before the process can be completed successfully, and, restrictions introduced by device manufacturers, service providers, or other entities associated with the device, payment account, or service.

### SUMMARY

Embodiments of the disclosed subject matter allow for service providers, such as card issuers and consumer device manufactures, to add functionality, such as contactless payments, to secure smart objects, such as wearables and other objects, without impacting existing fulfillment channels. As a result, all fulfillment channels used by service providers can be enabled, as the requirement to undertake the personalization process during fulfillment is removed. Additionally, the disclosed subject matter is applicable for use with computerized devices, such as Near Field Communications (NFC), enabled smart phones, using for example, Android® or iOS (Apple®) operating systems (OS).

Embodiments of the disclosed subject matter provide for the provisioning of data to secure smart objects, including wearables, for example, as communicated from a device, such as a smart phone (of a user or consumer), to render the secure smart object, for example, wearable suitable for actions, such as payments, authorization, identity, access control, ticketing, and consumer engagement. The aforementioned may be based on smart card applications.

Embodiments of the disclosed subject matter provide for personalization of a secure smart object, including a wearable, in a shorter time than is presently achievable, by contemporary systems.

Embodiments of the disclosed subject matter provide for personalization of secure smart objects, including wearables, using commands which are already existing on the computerized devices, such as smart phones.

Embodiments of the disclosed subject matter provide for an application or other software to be installed on a device, such as a smart phone or other computerized device. With the application activated, the device receives a data package including the personalization data, which will be transmitted to a secure smart object, such as a wearable. When the secure smart object, such as a wearable, which includes a chip, in the range of the device. The device transfers the entire data package to the chip. Once the data package is received, the chip processes the received package.

The disclosed system and process optimize the sending of individual commands from the device to the secure smart object, including a wearable, to reduce the quantity of data transferred to, and the number of operations needed to complete the transfer, performed by, the to the secure smart object, including a wearable.

Embodiments of the disclosed subject matter include a mobile application, downloadable to a computerized device, such as a mobile phone. The application connects to a computer, such as a server, which provides the data necessary to the computerized device, to personalize the secure smart object, such as a wearable.

Embodiments of the disclosed subject matter provide for the ability to accept personalization data for a conventional personalization and manipulate it such that it can be used for rapid personalization.

This document references terms that are used consistently or interchangeably herein. These terms, including variations thereof, are as follows.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software-based emulation of a computer.

An “application” includes executable software, and optionally, any graphical user interfaces (GUI), through which certain functionality may be implemented.

A “secure smart object” is an item that a consumer may possess that includes a chip, such as a smart card chip, which is capable of communication with a smart card terminal, for example a payment terminal. Secure smart objects, for example, include wearables, which may be worn by a consumer such as a ring, wristband, or jewelry, or be in possession of a consumer such as a key fob or card such as jewelry, biometric, display and metal card. Other embodiments may exist in addition to devices worn or in possession of the consumer, such as devices that are attached to or contained within the consumer or attached to or part of a device used by the consumer.

A “payment application” is, for example, an application conforming to the payment application specifications published by EMVCo (EMVCo is the global technical body that facilitates the worldwide interoperability and acceptance of secure payment transactions by managing and evolving EMV specifications and related testing processes), for example, EMVCo, LLC, A Guide to EMV Chip Technology, Version 2.0, November 2014 (hereinafter EMVCo Version 2.0), including, but not limited to, VSDC (as disclosed in VISA VSDC Contact & Contactless, U.S. Acquirer Implementation Guide, Version 3.0, June 2020) and VMPA (Visa Mobile Payment Application) by Visa, Mchip (M/Chip) Advance and Mchip (M/Chip) Mobile by Mastercard (MChip referenced in EMVCo Version 2.0), DPAS by Discover (referenced in EMVCo Version 2.0), AEIPS (American Express Integrated Circuit Card Payment Specifications which outline American Express (AMEX) EMV implementation requirements and referenced in EMVCo Version 2.0) and Expresspay (Expresspay is the American Express contactless specification, an EMV based payment specification that uses a contactless interface to communicate with a terminal and ensures global interoperability of American Express contactless payment transactions regardless of where they are processed), both from AMEX.

A “smartcard application” is any application that may be hosted and executed on a smart card. A payment application is one such application, however applications also exist for the purpose of authentication, identity, access control, ticketing, and consumer engagement. This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

Non-limiting examples of embodiments are described below with reference to figures attached hereto that are listed following this paragraph. Identical structures, elements or parts that appear in more than one figure are generally labeled with a same numeral in all the figures in which they appear, and a numeral labeling an icon representing a given feature in a figure may be used to reference the given feature. Dimensions of components and features shown in the figures are chosen for convenience and clarity of presentation and are not necessarily shown to scale.

FIG. 1 is a diagram that depicts an example environment in which the disclosed subject matter operates, in accordance with the disclosed subject matter;

FIG. 2A is a block diagram of a system associated with the Rapid Personalization (RP) server of the main computer system of FIG. 1, in accordance with the disclosed subject matter;

FIG. 2B is a block diagram of the chip of the wearable of FIG. 1, in accordance with the disclosed subject matter;

FIG. 3A is a flow diagram showing an example process in accordance with the disclosed subject matter;

FIG. 3B is a flow diagram of an example data package transferring from a device to a wearable (chip of the wearable) of block 314 of FIG. 3A, in accordance with the disclosed subject matter; and

FIG. 4 is a flow diagram of the example data package transfer process from the aspect of a chip of the wearable being personalized.

### DETAILED DESCRIPTION

### Overview

The present disclosed subject matter includes processes of communicating various data, including card data onto a chip of a secure smart object, such as a wearable. There are typically two separate and distinct processes to maximise the speed of data transfer or data transmission, from a computerized device, such as a smartphone, to the secure smart object, and improve the overall consumer experience. These processes include data transfer from a user device, such as a smartphone or other computerized device, to the secure smart objects, and once the transmitted data has been received, and the transfer is complete, the data is processed.

The present disclosed subject matter provides methods and systems provide for personalizing a secure smart object. The secure smart object, such as a wearable, and which includes a chip and a personalization application, receives a data package in a transmission from a device, such as a smart phone. Once the data package is received, and the transmission of the data page is complete, as confirmed or otherwise verified by a personalization application on the chip having executed a security check, such as a determination of matching hashes (digital signatures), the personalization application on the chip of the secure smart object processes the data package to create one or more personalized application instances on the chip of the secure smart object.

As used herein, the terms “transfer” and “transmission”, and derivatives thereof, are used interchangeably herein, when referring to movement of the data package, data, or other data items, such as hashes, between the user device or other computerized device and the secure smart object. For example, the data transfer to the secure smart object and its processing are performed as consecutive steps, as the transfer is complete before the processing begins.

When an interruption occurs during the data transfer (e.g., NFC tear), the user device has the ability to resume the transfer without needing to establish a new security (cryptographically protection) session, it can re-open the previous session, thus resuming the previous and typically the original session. This is because once the session begins, the session keys are stored by the chip of within the secure smart object, so there is no need to recalculate session keys by going back through the device to a server, to recalculate session keys, when an NFC tear occurs. Accordingly, the session may be reopened multiple times as necessary to complete the data transfer process. Additionally, to protect the chip of the secure smart object from any compromise of data during data transfer, as part of the process to open a security session, a hash or digital signature of the data to be transferred is transmitted to the secure smart device smartcard as part of the process to establish a security (cryptographically protection) session.

The secure smart object, i.e., the chip thereof, can hold multiple sets of pre-personalisation data and instruction sequences that can be referenced when transferring personalisation data to the secure smart object to minimise the amount of data that must be transferred. Only the differences between the pre-personalisation data and the final data to be written to the smartcard application therefore needs be transferred.

The data being transferred to the secure smart object may be compressed, and otherwise optimised to minimise both the amount of data, and the number of Application Data Units (APDU's). An APDU is the communication unit between the chip within a smart secure object and the device (e.g., the consumers mobile phone) that is transferring the data package. The structure of the APDU is defined by ISO/IEC 7816-4. that are required to complete the transfer. Once the secure smart object has received all required data and instructions, it shall start processing that data internally whenever it is powered (also known as “powered up” or “powered on”), and able to undertake such processing.

During processing of the data of the received data package, the personalization application ensures that all operations are atomic, and the overall process is either completed, or no permanent change is made to the configuration of the secure smart object.

The personalization application acts as a single point of contact on the secure smart object for the transfer and processing of personalisation data. For example, the personalization application manages the interface between to the device transmitting the data package and internally handles the personalizations of the individual applications on the secure smart object. The personalization application supports, for example, within one session, the transfer and ultimate personalisation of multiple smart card applications.

The smartcard applications typically do not require modification to be compatible with personalization application. The only requirement is that the smart card applications accept personalisation commands from the personalization application.

The present disclosure is directed to methods and systems, which provide for personalizing a secure smart device. The methods and systems are operable, for example, to provide data from data sources, such as payment cards, accounts and the like, to chips on secure smart devices, including, for example, wearables, such that the secure smart device is personalized with the requisite data and functionality. For example, account data, based on details of a card, such as a payment card (credit or debit) or other smart card application, authorization, identity, access control, ticketing, and consumer engagement, data from a tokenization platform or other sources of personalization data, may be obtained by a personalization server. The data package is transmitted to a device, for example, a smart phone, merchant terminal, tablet or laptop computer, or other computing device, for personalizing the wearable including transmitting the data package, i.e., transferring the data package, to a programmable chip, which includes a processing unit (including one or more processors, for example coupled to memory). Once the data package is received from the device, the chip processes the data package, as the data transfer element and the data processing element are separate processes.

The disclosed methods and systems are able to survive interruptions in the communication between the device and the chip, the interruptions for example, being tears, including near field communication (NFC) tears, or the chip being power cycled (e.g., powered down). Also, once the device has the data package, in the case of an interruption in the data transfer, the device can resume the data transfer of the data package without the need of establishing a new session, e.g., a new secure session, defined by the server from which it received the data package.

### System Description

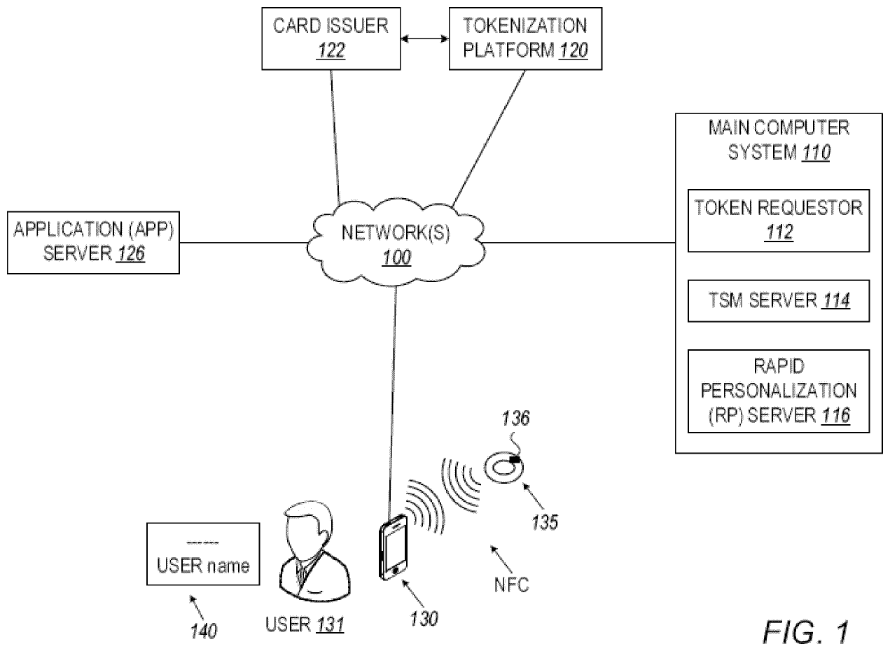

Reference is now made to FIG. 1, which shows an example environment in which personalization of a tokenized account or other source of personalization data of a debit, credit, or prepaid account in accordance with the disclosed subject matter is performed. The environment also supports direct personalization of authentication, identity, access control, ticketing, and consumer engagement accounts.

The environment includes one or more networks 100, which support communications, e.g., electronic and/or data communications, between components 110, 120, 130 in the environment. The networks 100 may include one or more of the Internet, Cellular networks, wide area networks (WAN) (of which the Internet is a public network thereof) and local area networks (LANs), such as an enterprise network.

A main computer system 110 communicates with the network 100. The main computer system 110 includes one or more computers including servers for providing personalization data from a data provider. The servers of the computer system 110 include, for example, a token requestor, represented by the server 112 (also referred to herein as a token requestor server), a Trusted Service Manager, represented by server 114, also referred to as a Trusted Service Management (TSM) server, and a Rapid Personalization (RP) server 116 (also referred to herein as a Personalization server).

The token requestor server 112 functions to collect the cardholder's existing card details and packages this data in a format accepted by the tokenization platform 120 such that the cardholder's card can be tokenized.

The TSM server 114 receives personalization data from the tokenization platform and manages the process of forwarding the personalization data to the wearable 135. In this disclosure the TSM server 114 functions to instead send or pass the personalization data to the RP server 116, which then re-formats the personalization data, for forwarding to the wearable 135. For example, the functionality of the RP 116 server may be included directly within the TSM server 114, such that only one physical server may be used. The tokenization platform 120 itself may also be extended to consume the functionality of the main computer system 110 including the functionality of the rapid personalization (RP) Server 116. The Tokenization platform 120 as currently operated by Mastercard (MDES), Visa (VTS) or Thales (TSH) and, for example, is responsible for providing account data sufficient that a token can be personalized to the wearable 135. In the execution of that task, the tokenization platform 120 may interface with the card issuer 122 to ensure only accounts authorized by the card issuer 122 are tokenized. In some embodiments however, it may be the Card Issuer 122, or a party working on their behalf who directly provides the account data to the TSM server 114.

The RP server 116 functions to translate the personalization data received from the tokenization platform 120 or card issuer (server 122) and translates it into a format compatible with the wearable 135, for personalizing a chip 136 (also known as a smart card chip, processor chip or microprocessor chip) coupled to and, for example, within the wearable 135. The RP server 116, for example, creates a data package and a hash (also known as a digital signature) linked to the data, and transmits the data package and hash to the device 130.

As used herein in this document, an “NFC tear” occurs, for example, when communication between two NFC devices, such as a smart phone 130 and a secure smart object 135, is interrupted when one of the devices, e.g., smart phone 130 or secure smart object 135, has been moved outside the communication range of the other device, causing the chip 136 to lose power. In this document “NFC tear” is also used to describe any communication failure(s) between the user device 130 and the chip 136 within the secure smart object 135 that cannot be recovered immediately through the NFC transport layer protocol and error recover mechanism.

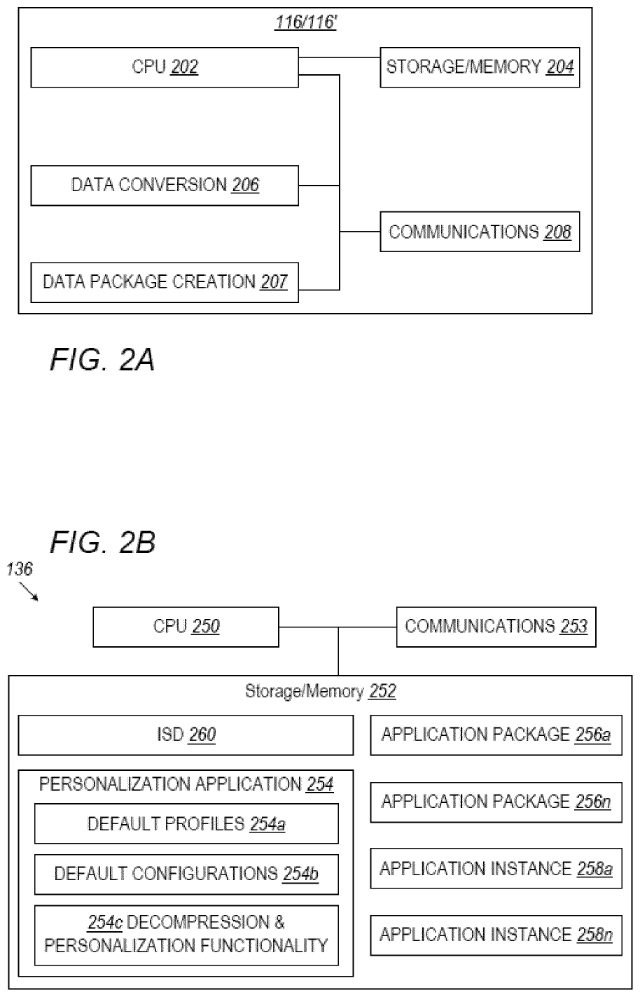

The RP server 116 includes a system 116′ of components, for performing various portions and operations of the disclosed subject matter. The RP server is detailed in FIG. 2A, to which attention is also directed. The RP server 116, for example, takes standard personalization data, for example, from the tokenization platform 120/card issuer server 122, via the TSM server 114 and converts it to a standardized format compatible with the chip 136, a programmable chip, within the secure smart object 135.

The personalization data is sent as a data package to the user device 130, for example, a smart (mobile or cellular) phone in communication 130 with the network(s) 100. The user device 130, when in communication with the secure smart object 135, for example, by near field communication (NFC) transmits a hash upon establishment of a cryptographic session or session followed by and/or contemporaneous or simultaneous with transmission of the data package to the chip 136 on the secure smart object 135.

The secure smart object 135, for example, can hold multiple sets of pre-personalisation data and instruction sequences that can be referenced when transferring the data package to the secure smart object to minimize the amount of data that must be transferred. Only the differences between the pre-personalisation data and the final data to be written to the smartcard application therefore needs be transferred.

FIG. 2A is a block diagram showing the architecture of a system 116′, for example, of the RP server 116. The system 116′ is such that one or more of the components, modules, and the like of the system 116′ may be external to the RP server 116, including, for example, in the cloud. As used herein, a “module”, for example, includes a component for storing instructions (e.g., machine readable instructions) for performing one or more processes, and including or associated with processors, e.g., the CPU 202, for executing the instructions. Other components are also permissible in the computer system 110, and all components in the system 116′ are linked to and in communication with each other, as well as other components linked to the system 116′ via the network(s) 100, either directly or indirectly.

The Central Processing Unit (CPU) 202 is formed of one or more processors, including microprocessors, for performing functions and operations detailed herein. The processors are, for example, conventional processors, and hardware processors, such as those used in servers, computers, and other computerized devices. For example, the processors may include x86 Processors from AMD (Advanced Micro Devices) and Intel, or other processors by companies such as ARM, as well as any combinations thereof.

The storage/memory 204 stores machine executable instructions for execution by the CPU 202. The storage/memory 204 also includes storage media for temporary storage of data. The storage/memory 204 also includes machine executable instructions associated with the operation of the modules 206, 207, and the communications interface 208.

The data conversion module 206 operates, for example, to process, or otherwise convert, received account data (as received from the trusted service manager 114) into a data package, to be transmitted to and processed by the chip 136 of a secure smart object 135, as received from a device 130, for personalizing the secure smart object 135.

The data package creation module 207 functions, for example, to prepare a package (i.e., a data package) of transferrable data to personalize the secure smart object 135, which is sent to the device 130, and, for example, along with one or more hashes linked to or otherwise associated with the data package, and typically a single hash. For example, the data being transferred to the secure smart object 135 may be compressed, and otherwise optimised to minimise both the amount of data, and the number of APDU's that are required to complete the transfer. Once the secure smart object 135 has received all required data and instructions, it shall start processing that data internally whenever it is powered and able to undertake such processing.

The communications module 208 or interface sends and receives data from the RP server 116 to the other components 112, 114 of the computer system 110, the device 130, over the network(s) 100, as detailed herein.

Returning to FIG. 1, The network(s) 100 are used for communication with a tokenization platform, represented by the server 120 (the tokenization platform and server interchangeably referred to by element number 120), which may be the source of the data necessary to allow for personalization of the secure smart object 135, via the device 130, with data associated with each card 140 (credit/debit/prepaid) of the user 131. The server 120 communicates with a server 122, representative of a card issuer, e.g., the organization who issues a credit/debit/prepaid payment card. The card issuer 122 may also be the source of the data necessary to allow for personalization of the secure smart object 135 without the functionality of the tokenization platform 120 but using another party or functionality within the TSM server 114 to perform data generation.

An application (APP) server 126, in communication with the network(s) 100 and, for example, maintains and stores downloadable (for example, by the device 130) applications for communicating with the secure smart object 135 (by the smart phone 130) using near field communication (NFC). For example, the application server 126 may host an application service or aggregator, such as Google® Play® Store. The Manage-Mii® application discussed herein is, for example, available from the application server 126, for example, from Google® Play®. A device 130, such as a smart phone, associated with a user 131, representative of devices and their associated users communicates with the networks(s) 100, and each device 130 associated with a secure smart object 135 (also associated with the user 131). The secure smart object 135 is, for example, an article including a programmable chip or processing unit 136, or other data retrievable device, and may be, for example, in the form of a watch, ring, shirt, keychain, wallet, and ‘exotic’ cards, such as jewelry, biometric, display and metal cards, or the like. The chip 136 is a programmable chip, programmable from the device 130 by wireless communications, such as Near Field Communication (NFC), and the chip 136 is, for example, compatible with the RP server 116, with respect to the data package (and hash).

The chip 136 is typically part of the secure smart object 135, for example, coupled, attached and/or connected thereto, in communication therewith, or incorporated thereon or therein, or otherwise associated with the secure smart object 135. Turning also to FIG. 2B, the chip 136 includes and/or supports, for example, a central processing unit (CPU) 250 (also known as a “data processing unit”) including, for example, one or more processors coupled to storage/memory 252. A communications module 253 is also in communication with the CPU 250 and the storage/memory 252.

The CPU 250 of the chip 136 has suitable processing and storage capabilities to perform the operations disclosed herein, including performing the operations of receiving the data package (and hash linked thereto), processing the data package, recalculating the hash once processing is finished, comparing the hash, and performing actions based on the hash matching, taking action and, for example, in the form of commands and/or instructions, for example, associated with applications, programs and the like, for “personalizing” the chip 136 of the secure smart object 135, and allowing the secure smart object 135, for example, to operate as a payment device, like a payment card, as the processing unit causes the transmission of payment data and or payment signals, in response to receiving data or signals from a payment requesting computer or computerized device, well as performing other functions.

The communications module 253 communicates with the user device 130 and user interfaces (e.g., signal and/or data transceivers), and is programmable, and as such, is programmed to perform various operations. When communicating with the user device 130, the hash and data package are being transmitted to the chip 136. The communications module 253 also communicates with the user device 130 or other powering device or unit, for powering of the secure smart object 135, when the chip 136 is, for example, within Near Field Communication (NFC) range of the user device 130 or other powering device (e.g., a payment terminal or merchant terminal at a point of sale).

The storage/memory 252 includes, for example, a personalization application 254, application packages 256a-256n with corresponding application instances 258a-258n, and an Issuer Security Domain (ISD) 260. All of the components of the storage/memory 252 are in communication with the CPU 250 and communications module 253, directly or indirectly.

The personalization application 254 serves to provide instructions to the CPU 250 to perform operations including, receiving the hash and the data package, processing the data package so as to personalize the secure smart object 135, recalculating the hash (e.g., once the transfer of the data package is complete), comparing the received hash to the recalculated hash, and taking action based on the comparison (matching) of the hashes.

The personalization application 254 includes default profiles 254a for representing the data typically used to personalize a specific smartcard application, and present to minimize the data required to be transferred to the personalization application 254 to undertake Personalization of the smartcard application and default configurations 254b, for defining the sequence of steps required to create an instance of a specific application or delete a specific application from the smartcard. There is also a decompression and personalization functionality 254c, which is responsible to processing the data bundle and performing the personalization of applications within the smartcard.

The personalization application 254 acts as a single point of contact on the secure smart object 135 for the transfer and processing of personalisation data. The personalization application 254 supports, for example, within one session, the transfer and ultimate personalisation of multiple smart card applications.

The smartcard applications typically do not require modification to be compatible with personalization application. The only requirement is that the smart card applications accept personalisation commands from the personalization application 254.

Application Packages (applications) 256a-256n on the chip 136, e.g., programmed onto the chip 136, represent the code of required instructions to create an instance 258a-258n of an application 256a-256n, such that the personalization application 254 may create further application instances as required in the data packages the chip 136 receives and processes. An application instance 258-258n is, for example, the instantiation of an application module which holds the executable code for the application stored on the chip which then allows that module (package) to be executed (run) and maintain persistent and non-persistent data.

For example, there may be multiple application instances from a single application package. Also, for example, payment card applications, such as payment cards, may all be MasterCard®, which uses the same application module and package, but different instances, due to the different issuers, such as Capital One (one application instance) and Citibank (a different application instance).

The underlying ISO/IEC 14443 protocol implemented by the operation system of the chip 136 already contains checks for communication errors and functionality to automatically request re-transmission of data should communication errors be detected. The Personalization application 254 then functions to verify the authenticity of the data package, as each APDU (application data unit) has received a basic check of its integrity, which is performed to ensure that each APDU has not been modified from what the RP server 116 originally sent to the user device 130. In addition, once all data is received. the entire data package, the hash (e.g., recalculated from the data package) of the entire context of the data package is confirmed against the hash (i.e., original hash) declared when the initial secure session was established. If any integrity or data checking fails, an error is transmitted back to the user device 130, and processing stops, and does not proceed. The session is permanently abandoned.

The personalization application 254 functions to verify that the secure session is opened with the personalization application verifying and ensure the authenticity and integrity of the data package sent during the data transfer process. The personalization application will confirm every block (APDU) sent to it and the integrity of every one of the sent data blocks with the necessary encryption and decryption data necessary to ensure confidentiality of the data being transferred. The personalization application can personalize the preconfigured data in the newly created instance. Typically, the personalization application will combine the data received in the data package with any data referenced by the data package which it already knows. This creates a complete set of personalization data which the personalization application will use to create the newly created instance.

An Issuer Security Domain (ISD) 260 is a term and functionality defined by Global Platform®, for example in GlobalPlatform Card Specification Public Release v2.3.1 (March 2018) from Global Platform, Inc., hereinafter “Global Platform Specification”, and typically is present on all implementations of a Java Card (a smartcard chip able to execute applications written in Java). Its role is to act as security manager on the chip 136, only allowing functionality to be undertaken that is permitted by the owner of the chip 136. It also allows the owner to authenticate with the chip (via a cryptographic challenge) in order to access privileged functions not available to any entity unable to complete the authentication process. Other smartcards may not use an Issuer Security Domain, however using different methods offer similar functionality. When referring to an Issuer Security Domain (ISD) 260, reference is also made to any such similar functionality that may be used by other types of chips.

Security counters are, for example, programmed into the chip 136. The security counters are, for example, used to protect the chip 136, from a brute force attack, where the attacker attempts multiple times to break into a device. Also, the security counters are, for example, set such that multiple NFC tears typically cause the chip 136 to enter a protected state. In a controlled environment, communication errors, such as NFC tears, for example, are not common. Accordingly, the security counters may, for example, be set very low (e.g., three attempts). However, in an uncontrolled environment such as a consumer undertaking the personalization process, such NFC tears should be anticipated, so a higher threshold should be set before invoking security measures. Typically, brute force attacks involve hundreds or thousands of attempts, so increasing the threshold to 20 or 30 attempts typically has no meaningful impact on the security of the device 130.

Additionally, by including personalization data in the application 254 used to personalize the chip 136, when the instance is first created, for example, when much of the personalization data normally sent to the chip 136 is well known in advance, the amount of personalization data that needs to be transferred to the chip 136 from the user device 130 can be reduced. This helps to speed up the data transfer process and therefore yield a better consumer experience. If any data that has been pre-personalized is found not to match what is required, it can however be in whole or in part overwritten on the chip 136.

In alternative embodiments, rapid personalization may be supported by pre-personalizing the secure smart object 135, e.g., the wearable. Where a secure smart object 135 is intended to be personalized by a known Issuers account, for example with a prepaid account, it is possible that the majority of the account data for that account can be pre-personalized with the exception of the Payment Account Number (PAN) and data directly linked with it. This allows the majority of data to be pre-personalized facilitating a very rapid final personalizing by the consumer. In such an embodiment, only when the consumer (user 131) agrees to activate the account, potentially after they have also agreed to load some initial funds, is the personalization of the account finalized and the account activated. By having a very specific pre-personalization data available on the chip 136, the amount of data that must be transferred in the data package, and the processing required will be significantly reduced, potentially yielding a 1 second (very rapid) personalization, and an optimized consumer experience. This can be beneficial to the issuer, especially a prepaid issuer, if a large number of secure smart objects are being issued, but the number of secure smart objects135 that will ultimately be used to perform payment functionality is anticipated to be low. This process will save the Issuer from incurring any payment scheme and payment processor fees for issuance of accounts that ultimately are never activated.

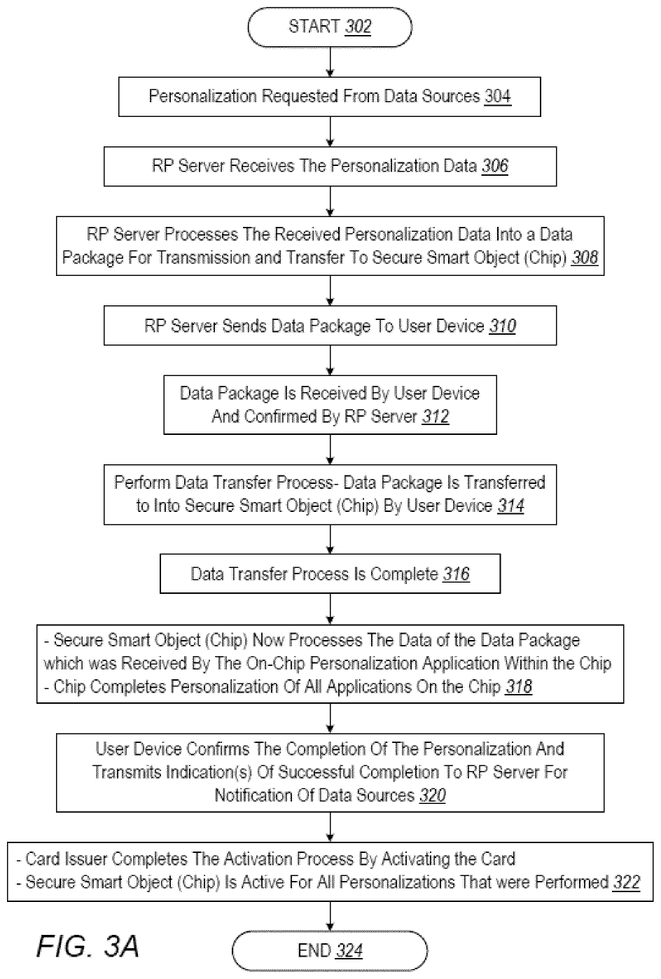

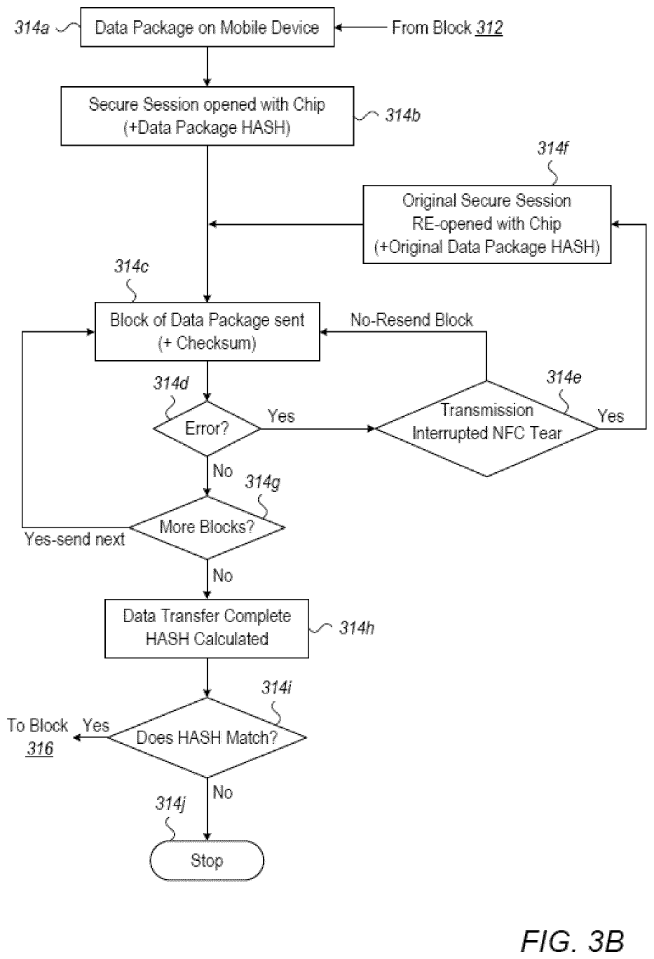

FIGS. 3A and 3B are flow diagrams detailing computer-implemented processes and sub-processes in accordance with embodiments of the disclosed subject matter. These processes, for example, are performed by a computer system, such as the main computer system 110 of FIG. 1, including the server system 116′ of FIG. 2A. The aforementioned processes and sub-processes are, for example, performed automatically and in real time.

The process begins at block 302, a START block. At the START block 302, the user 131 obtains the requisite secure smart object 135, including the programmable chip 136 (for example, including the processing unit as detailed above) compatible with the RP server 116. The user 131 (via his device 130) also downloads an application (for example, from the Application (APP) Server 126, which supports receiving the data package for personalizing the secure smart object 135, with a data package received from the device 130, as detailed at block 314 below.

Alternately, the personalization application 254 may also be preinstalled on the device 130. The personalization application is, for example, also for communicating (electronic and/or data communications) with the secure smart object (for example, via NFC), to transfer data, for example, a hash (one or more) and a data package (the hash linked to the data package) for programming the chip 136, e.g., personalizing the chip 136 with the user's card data (e.g., of card 140).

The Personalization application 254 connects to the RP server 116. The application may be, for example, the Manage-Mii™ application from DIGISEQ of London, UK. The Manage-Mii™ application is a mobile application that allows a smart phone or other user device to add a service to the secure smart object, such as a wearable, track the service's activity, allow for user changes of bank services with the secure smart object, for example, add or delete displayable payment and payment card features, and the like. For example, the Manage-Mii™ application facilitates provision of information, for example, bank card details, from a device onto a secure smart object. Other applications may be used. The user 131 adds the secure smart object 135, for example, the wearable, to the application. Additionally, the user 131 selects the service that they want to provision onto the secure smart object 135, for example, a prepaid or tokenized account.

The user 131 enters, via his device 130, his card 140 details, for example, of the card 140 being a credit, debit or other type of payment card, and sends these details to the computer system 110, for example, the token requesting server 112. The user 131 may also have his card 140 details stored or otherwise supplied to the application such that they may not need to directly enter the details themselves. The process now moves to block 304, where the aforementioned card details are received by the token requesting server 112 of the computer system 110.

Staying in block 304, the token requestor server 112 sends (transmits) the received card details to the tokenization platform 120. In response, the tokenization platform 120 provides a confirmation (e.g., via a data transmission) to the token requestor server 112.

Moving to block 306, the tokenization platform 120 sends the trusted service manager server 114, of the computer system 110, the account data, which the device 130 will personalize on the secure smart object 135. The trusted service manager server 114, then sends (transmits or otherwise passes) the aforementioned account data to the RP server 116, which receives this personalization data, at block 306.

The RP server 116, having received the account data, at block 306, processes this received account data into a data package transmittable to, via the device 130, and processable by the chip 136 of the secure smart object 135, with the data, at block 308. The data is of a format compatible with the device 130 and the chip 136 of the secure smart object 135, both receiving the data package and for the chip 136 to process the data of the received data package.

The process moves to block 310, where the RP server 116 sends (transmits or otherwise passes) the aforementioned data package (e.g., writable data) to the device 130 (via the network(s) 100). The process then moves to block 312, where the data package, and, for example, one or more hashes linked to or otherwise associated with the data package, are received by the device 130, and confirmed by the RP server 116.

At block 314, a transfer of the data package to the chip 136 the data package including data necessary to personalize the secure smart object 135 to render it usable, for example, as a EMV compliant Payment device, access control device, Identity device, or loyalty device, is transmitted to the secure smart object 135 (i.e., the chip 136), from the device 130. The transmission or sending of the data package from the device 130 to the secure smart object 135 is, for example, by a near filed communication (NFC) or other type of electronic and/or data communication(s). The transfer (or transmission) process, where the data package is transmitted from the device 130 to the chip 136, begins once a cryptographic session or pipe is opened between the device 130 and the chip 136. Additionally, upon the opening of the cryptographic session, for example, and just prior to the transmission of the data package from the device 130 to the chip 136, one or more hashes, typically one hash, linked to the data package, are transmitted from the device 130 to the chip 136. The actual process of the transmitting the data package between the device 130 and the secure smart object 135 (i.e., chip 126) is described in greater detail below and shown in the flow diagram of FIG. 3B.

Optionally, but usually, during the data package transfer from the device 130 to the secure smart object 135, for example, at block 314, minimal but sufficient checks are performed to make sure that the data is transmitted as intended, and therefore, without being corrupted. For example, as the data package is sent from the device 130 to the chip 136, three checks are performed. These checks include, for example, checks for transmission errors undertaken in accordance with the ISSO 14443 Protocol, checks of the Message Authentication Code (MAC), a cryptographic checksum on data that uses a session key to detect both accidental and intentional modifications of the data, which is applied to each APDU, and checking of the hashes, original and recalculated, for an identical match. The checks may be in the aforementioned order or sequence but do not have to be.

A checksum is checked to detect communication errors. The checksum (a data calculation performed over the data sent designed to identify data corruption due to communication errors) operates via a contactless transport layer protocol (ISO IEC 14443).

The MAC applied to each APDU and checked at the application layer to ensure integrity and authenticity of the APDU being transferred. For example, the MAC makes sure that there are not any attempts to adjust or modify the data within the APDU, forming part of data package transfer.

In previous personalization methods, prior to the subject matter disclosed herein, the session is only open for as long as the smart secure object (chip) is powered, typically a very short period (seconds). In this disclosure, the smart secure object 135, e.g., the chip 136 therein, can be powered down, and the session subsequently re-established, facilitating the life of the session keys being substantially longer. As the session can be re-opened after any length of time (as the chip 136 is insensitive to time), for example, weeks, months and even years, this could introduce a security vulnerability, other countermeasures must therefore be introduced to detect an attacker attempting to modify the data being transferred in the data package.

A hash of the entire data package is checked for an identical match to confirm the integrity and authenticity of the entire data package (data package as a whole). The hash is used as a compensating control to protect against a bruit force attack of the session keys, due to the potential extended life of the session keys.

For example, as the hash is recalculated from the transferred data, even if the session is not resumed for a long time, for example, weeks, months, years, a third party (e.g., imposter), even if successfully breaking into the session, will not be able to match the hashes, as any change to the data will result in a different hash being re-calculated.

Moving to block 316, the transmission of the data package to the chip 136 of the secure smart object 135 is successfully completed. This was achieved in block 314, for example, by a determination that the hashes match. The hashes are the transmitted hash and a matching a hash calculated on the chip 136. This is discussed in detail with reference to blocks 314g and 314h of FIG. 3B, below.

The process then moves to block 318, where the processing of the data of the data package is now performed on the chip 136. This process is such that the data of the data package is processed on the chip 136 for each application on the chip 130, in order that the chip 136 completes all personalization of all applications 256a-256n on the chip 136. For example, the data package is processed by the personalization application, for example, when the chip is powered on, by a power source, such as an NFC reader or terminal. During the data processing, the personalization application ensures that all operations are “atomic”, and the overall process is either completed, or permanent change is not made to the configuration of the secure smart object 135.

Moving to block 320, the user device 130, having received an indication from the secure smart object 135 of the completion of the data processing onto the chip 136, for example, the indication representative of the aforementioned hashes match, confirms the completion of the personalization of the chip 136 on the secure smart object 135. The device 130 relays (transmits) the indication to the RP server 116, for the RP server 116 to notify data sources of the completed personalization(s) of the secure smart object 135. At block 322, the card issuer server 122, if required, completes the activation process associated with the card 140 and the secure smart object 135, and once completed, the secure smart object 135 is usable, for example, as a payment device. The process moves to block 324, where it ends.

FIG. 3B is a flow diagram of the data package transmission operation (process) from the device 130 to the chip 136 of the secure smart object 135, such as a secure smart object 135, of block 314, which is provided in detail. The process begins at block 314a (from block 312), where the data, as the data package and a linked hash, is received by the device 130, from the RP server 116, as detailed above, and stored in the device 130. The device 130 is active, and, for example, running the Manage-Mii™ application.

The process moves to block 314b, where the device 130 prompts the user 131 to place the secure smart object 135 (with its chip 136) into the range of NFC with respect to the device 130. A secure session, which is, for example, a cryptographic session, is opened between the device 130 and the secure smart object 135, which includes transfer of the data package and a linked or otherwise associated hash. The hash locks in the payload, i.e., the data package, on the secure smart object 135, and by using the hash, the integrity of the session cannot be compromised.

Moving to block 314c, with the secure smart object 135 in the field of the NFC, the device 130 opens (also known as negotiation) a cryptographic session, for example, as a secure session with a first or next block of data (of the data package) transmitted to the chip 136. The transmitted data block may be encrypted (for confidentiality) and MACed (for authenticity), and, for example, prevented from transmission errors by the underlying ISO 14443 Protocol. The session initially is open until the chip 136 is powered off, however it can be re-opened data transfer using the session keys calculated in the initial session can be used to continue the data transfer once powered up again, if previously powered down. This cryptographic method is performed to make sure that the data sent is the original data as provided by the personalization server.

The process moves to block 314d, where the transmission process for the data package is monitored for errors. These errors may include, for example, communication errors, such as not all of the data transferred correctly. Should there be an error at block 314d, such as a communication error, it is determined whether the transmission has been interrupted, for example by an NFC tear, at block 314e. If the interruption is not an NFC tear, the process moves to block 314c, from where it resumes.

However, at block 314e, if the interruption is an NFC tear, the process moves to block 314f, where the original secure session (cryptographic session which was negotiated) is reopened by reference to the original hash, with the chip 136 (and the device 130) and data transfer of the original data package resumed. The session (i.e., original session) will only reopen if the hashes match.

For example, when an interruption occurs during the data transfer (e.g., NFC tear), the user device 130 has the ability to resume the transfer without needing to establish a new security (cryptographically protection) session. The user device 130 can re-open the previous session. Additionally, to protect the chip 136 of the secure smart object 135 from any compromise of data during data transfer, as part of the process to open a security session, a hash or digital signature of the data to be transferred is transmitted to the secure smart device 135 as part of the process to establish a security (cryptographically protection) session.

For example, also, if an interruption occurs during the data transfer, the user device 130 can reopen the session, on request to the personalization application, by submitting the original hash (transmitted with the data package and cryptographic data, including, for example, session keys (cryptographic session keys) upon the opening (negotiation) of the cryptographic session. The session keys, for example, 3DES (Triple Data Encryption Algorithm) or AES (Advanced Encryption Standard) session keys, and the cryptography, which was established (negotiated) when the original session was opened, are used to continue the data (data package) transfer. If the hash recalculated from the transferred data does not match the originally provided hash, and an attempt is made to reopen the session with the incorrect hash, typically after multiple attempts, then the session will be permanently terminated, at block 314j.

The cryptographic session, for example, is negotiated in a similar manner to that defined by commonly defined methods, including, but not limited to the SCP02 and SCP03 protocols as defined by the GlobalPlatform Specification. The primary difference is that the hash of the data package is communicated during the initial negotiation of the cryptographic session, and that a new command is included to allow an existing cryptographic session to be reopened by the device 130. To reopen a cryptographic session, the hash originally communicated during the initial negotiation of the cryptographic session is resent to the chip 136 to confirm that the device 130 knows the hash of the data package from when the cryptographic session was initially opened. The actual method of transferring the hash and re-opening the cryptographic session may vary between implementations depending on the cryptographic functionality supported by the chip 136. Also, at block 314e, the system is such that should there be an NFC tear, the existing session is opened from the device 130. This is in contrast to other systems, where the session can only be reopened by going back to the RP server 116 or other server upstream of the user device 130.

From block 314e, the process moves to block 314c, from where it resumes.

Returning to block 314d, should there be no error detected in the transfer of the data block (of the data package), the process moves to block 314g, where it is determined whether there are more data blocks to transfer. If yes, the process moves to block 314c, from where the process resumes. If no at block 314g, the process moves to block 314h.

At block 314h, the data transfer from the device to the chip 136 of the secure smart object 135 is now complete and the hash is calculated, for example, by being recalculated (or rebuilt) from the transferred data (e.g., of the data package).

The process moves to block 314i where it is determined whether the hashes match, the hashes being the originally transmitted hash and the recalculated hash. If yes, the process moves to block 316, where the data transfer is now complete. From block 316, the data package is processed by the personalization application, for example, when the chip is powered on, by a power source, such as an NFC reader or terminal.

Returning to block 314i, if there is not a match of the hashes, the process moves to block 314j, where it ends. In this case the data has been corrupted and is not processed. The entire process must be restarted, as the session keys are likely compromised.

The processes and subprocesses detailed in FIGS. 3A and 3B, from blocks 302 to 324, including blocks 314a-314j, may be repeated for as long as necessary.

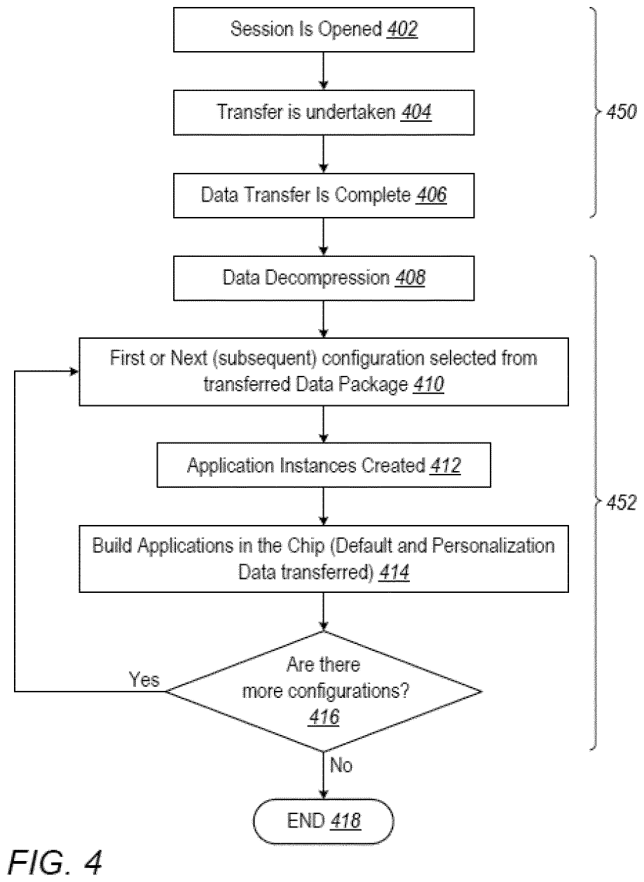

FIG. 4 is a flow diagram detailing computer-implemented processes and sub-processes in accordance with embodiments of the disclosed subject matter. These processes, for example, are performed with respect to the chip 136 of the secure smart object 135, and in particular detail the processes and subprocesses performed upon processing the data of the transferred data package to the chip 136. The aforementioned processes reference FIGS. 1, 2A and 2B. The aforementioned processes and sub-processes are, for example, performed automatically and in real time.

Initially, at block 402, the cryptographic session was opened. The data package transfer from the device 130 to the chip 136 was performed, at block 404, and the transfer of the data package was complete, at block 406.

The process moves to block 408, where the data is decompressed and ready for processing. The process moves to block 410, where a first application or configuration, for example, the personalization application 254 has its data processed. A corresponding application instance 258a-258n is created for the personalization application 254, at block 412.

The application moves to block 414, where applications are built in the chip 136, with the requisite default and personalization data having been transferred to the chip 136 in the data package. For example, any default data associated with the application is processed with the data for the application from the data package. Within the data package are the details of the application to be used, the application instances to be created from the stored data packages on the secure smart object 135, any data that has been stored by the personalization application, and dynamic data received in the data package itself. This information is used to create the appropriate application instance and to personalize that application instance using the dynamic data received in the data package combined with any static data held by the personalization application and received by the data package. The data package may contain one or more sets of details and the personalization application will step through each one until all instances have been created and personalized.

At block 416, the data package which has been transferred, is now examined for additional applications, for processing on the chip 136, so as to be active on the chip 136 (e.g., secure smart object 135). If yes, an additional application has been found and will be configured, in accordance with the process, which returns to block 410. The process resumes from block 410.

Returning to block 416, should there not be any more applications, the process moves to block 418, where it ends.

As shown by the bracket 450, the processes of blocks 402, 404 and 406 are performed between the device 130 and the chip 136, as the chip 136 needs power from and needs to be in communication (e.g., NFC communication) with the device 130. The bracket 452 is applicable to blocks 408, 410, 412, 414, and 416, where the chip 136 need only be in communication with a power source, to provide power for the chip. The processes of blocks 408, 410, 412, 414 and 416 typically must be “atomic”, as the interruption of power does not cause loss of the processes, only a resuming thereof.

### EXAMPLES

### Example 1

A method for personalizing a secure smart object comprising: obtaining personalization data from a data provider; processing the personalization data into a data package for transfer to a personalization application to a chip of a secure smart object; and, transferring the data package to a device, for personalizing a chip of the secure smart object; and, transferring the data package to the chip of the secure smart object from the device, and when the transfer of the data package is complete, the personalization application processing the data package to create one or more personalized application instances on the chip of the secure smart object.

### Example 2

The method of Example 1, wherein the data package transferred to the chip includes an associated hash, and upon the transfer of the data package being complete, recalculating the hash by the personalization application being executed by the chip from the data of the data package, and confirming whether the data package transferred to the chip is complete and identical to that sent by the personalization server by testing whether the transferred hash matches the recalculated hash, and, if the transferred hash matches the recalculated hash, the personalization application processes the data package to create one or more personalization application instances on the chip of the secure smart object.

### Example 3

The method of Example 1 or Example 2, wherein the data provider includes a tokenization service.

### Example 4

The method of any of Example 1 to Example 3, wherein, wherein the processing of the personalization data into the data package includes compressing the personalization data to minimize the quantity of data that must be transferred.

### Example 5

The method of any of Example 1 to Example 4, wherein the device stores the data package until transfer of the data package is determined to be complete.

### Example 6

The method of any of Example 1 to Example 5, wherein the transferring the data package to the chip of the secure smart object includes transferring the data package in one or more data blocks.

### Example 7

The method of any of Example 1 to Example 6, wherein the personalization application before processing the data package validates the integrity and the authenticity of the data package.

### Example 8

The method of any of Example 1 to Example 7, wherein the personalization application creates one or more application instances defined by the data package.

### Example 9

The method of any of Example 1 to Example 8, wherein the personalization application includes prestored static data for being combined with dynamic data received in the data package, to create the one or more application instances.

### Example 10

The method of any of Example 1 to Example 9, wherein the data received in the data package is stored by the chip as a predefined script.

### Example 11

The method of any of Example 1 to Example 10, wherein the secure smart object includes a wearable, biometric card, metal card or other smart card.

### Example 12

The method of any of Example 1 to Example 11, wherein the device includes a mobile phone, merchant terminal, tablet or other computerized device.

### Example 13

A method for securing the transfer of data from a device to a chip of a secure smart object comprising: negotiating a cryptographic session between the device and the chip of the secure smart object, for the transfer of the data, including creating cryptographic data; transferring a hash of the data to be transferred during the cryptographic session, as a portion of the negotiation; and, continuing the negotiated cryptographic session while the chip is powered, and, if the negotiated cryptographic session and the transfer of the data is interrupted from a power loss to the chip, resuming the transfer of the data using the session keys created when the session was negotiated.

### Example 14

The method of Example 13, wherein the cryptographic data includes session keys.

### Example 15

The method of Example 13 or Example 14, wherein the session keys include 3DES or AES session keys.

### Example 16

The method of any of Example 13 to Example 15, wherein the transfer of the data includes comparing the transferred hash to a hash recalculated by the personalization application being executed by the chip from the transferred data, to determine whether the transferred data may be processed by a personalization application of the chip.

### Example 17

The method of any of Example 13 to Example 16, wherein the transferred hash is declared when the cryptographic session is negotiated.

### Example 18

The method of any of Example 13 to Example 17, wherein when the cryptographic session is to resume, the device must correctly confirm the transferred hash that was declared when the session was negotiated.

### Example 19

The method of any of Example 13 to Example 18, wherein the data for the transfer of the data is provided to the device by one or more secure provisioning servers, such that when transferred to the device as a data package, the data package can be re-transmitted as many times as required by the device to the chip of the secure smart object in order to fully transfer the data package to the secure smart object, without re-calculation of the cryptographic data by the one or more secure provisioning servers.

### Example 20

The method of any of Example 13 to Example 19, wherein a new cryptographic session cannot be set up between the user device and the chip of the secure smart object without re-calculation of the of cryptographic data by the one or more secure provisioning servers.

### Example 21

The method of any of Example 13 to Example 20, wherein the cryptographic data includes session keys.

### Example 22

The method of any of Example 13 to Example 21, wherein the validity of the cryptographic session is terminated once the data is: 1) successfully transferred to the chip of the secure smart object, or 2) on request of the device or any one of the one or more secure provisioning servers.

### Example 23

A method for personalizing one of more applications on a chip of a secure smart object through a personalization application present on the chip of the secure smart object, the method comprising: configuring the personalization application to include security privileges on the chip of the secure smart object to create application instances and personalize the application instances; providing memory on the chip of the secure smart object to receive and store a data package transferred to the chip of the secure smart object from the user device; and, the personalization application including one of more sets of pre-personalization data and command sequences, for combining with the with the data received in the data package, to minimize that the amount of the data transferred in the data package.

### Example 24

A system for personalizing a secure smart object comprising: a chip on a secure smart object including: a non-transitory storage medium for storing computer components; and, a computerized processor for executing the computer components comprising: a personalization application for receiving a data package transferred to the chip from a device; and, once the transfer of the data package is complete, the personalization application processing the data package to create one or more personalized application instances on the chip of the secure smart object.

### Example 25

The system of Example 24, wherein the secure smart object includes a wearable.

In the description and claims of the present application, each of the verbs, “comprise,” “include” and “have”, and conjugates thereof, are used to indicate that the object or objects of the verb are not necessarily a complete listing of components, elements or parts of the subject or subjects of the verb. Implementation of the method and/or system of embodiments of the disclosed subject matter can involve performing or completing selected tasks manually, automatically, or a combination thereof. Moreover, according to actual instrumentation and equipment of embodiments of the method and/or system of the disclosed subject matter, several selected tasks could be implemented by hardware, by software or by firmware or by a combination thereof using an operating system.

For example, hardware for performing selected tasks according to embodiments of the disclosed subject matter could be implemented as a chip or a circuit. As software, selected tasks according to embodiments of the disclosed subject matter could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub combination or as suitable in any other described embodiment of the disclosure. Certain features described in the context of various embodiments are not to be considered essential features of those embodiments, unless the embodiment is inoperative without those elements.

The above-described processes, including portions thereof, can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for personalizing a secure smart object comprising:
obtaining personalization data from a data provider;
processing the personalization data into a data package for transfer to a personalization application to a chip of a secure smart object;
transferring the data package to a device, for personalizing a chip of the secure smart object; and
transferring the data package to the chip of the secure smart object from the device, and when the transfer of the data package is complete, the personalization application processing the data package to create one or more personalized application instances on the chip of the secure smart object.

2. The method of claim 1, wherein the data package transferred to the chip includes an associated hash, and upon the transfer of the data package being complete, recalculating the hash by the personalization application being executed by the chip from the data of the data package, and confirming whether the data package transferred to the chip is complete and identical to that sent by the personalization server by testing whether the transferred hash matches the recalculated hash, and, if the transferred hash matches the recalculated hash, the personalization application processes the data package to create one or more personalization application instances on the chip of the secure smart object.

3. The method of claim 1, wherein the data provider includes a tokenization service.

4. The method of claim 1, wherein the processing of the personalization data into the data package includes compressing the personalization data to minimize the quantity of data that must be transferred.

5. The method of claim 1, wherein the device stores the data package until transfer of the data package is determined to be complete.

6. The method of claim 1, wherein the transferring the data package to the chip of the secure smart object includes transferring the data package in one or more data blocks.

7. The method of claim 1, wherein the personalization application before processing the data package, validates the integrity and the authenticity of the data package.

8. The method of claim 1, wherein the personalization application creates one or more application instances defined by the data package.

9. The method of claim 8, wherein the personalization application includes prestored static data for being combined with dynamic data received in the data package, to create the one or more application instances.

10. The method of claim 9, wherein the data received in the data package is stored by the chip as a predefined script.

11. The method of claim 1, wherein the secure smart object includes a wearable, biometric card, metal card or other smart card.

12. The method of claim 1, wherein the device includes a mobile phone, merchant terminal, tablet or other computerized device.

13. A method for securing the transfer of data from a device to a chip of a secure smart object comprising:
negotiating a cryptographic session between the device and the chip of the secure smart object, for the transfer of the data, including creating cryptographic data;
transferring a hash of the data to be transferred during the cryptographic session, as a portion of the negotiation; and
continuing the negotiated cryptographic session while the chip is powered, and if the negotiated cryptographic session and the transfer of the data is interrupted from a power loss to the chip, resuming the transfer of the data using the session keys created when the session was negotiated.

14. The method of claim 13, wherein the cryptographic data includes session keys.

15. The method of claim 14, wherein the session keys include 3DES or AES session keys.

16. The method of claim 14, wherein the transfer of the data includes comparing the transferred hash to a hash recalculated by the personalization application being executed by the chip from the transferred data, to determine whether the transferred data may be processed by a personalization application of the chip.

17. The method of claim 15, wherein the transferred hash is declared when the cryptographic session is negotiated.

18. The method of clam 16, wherein when the cryptographic session is to resume, the device must correctly confirm the transferred hash that was declared when the session was negotiated

19. The method of claim 13, where the data for the transfer of the data is provided to the device by one or more secure provisioning servers, such that when transferred to the device as a data package, the data package can be re-transmitted as many times as required by the device to the chip of the secure smart object in order to fully transfer the data package to the secure smart object, without re-calculation of the cryptographic data by the one or more secure provisioning servers.

20. The method of claim 19, wherein a new cryptographic session cannot be set up between the user device and the chip of the secure smart object without re-calculation of the cryptographic data by the one or more secure provisioning servers.

21. The method of claim 20, wherein the cryptographic data includes session keys.

22. The method of claim 19, wherein the validity of the cryptographic session is terminated once the data is: 1) successfully transferred to the chip of the secure smart object, or 2) on request of the device or any one of the one or more secure provisioning servers.

23. A method for personalizing one of more applications on a chip of a secure smart object through a personalization application present on the chip of the secure smart object, the method comprising:
configuring the personalization application to include security privileges on the chip of the secure smart object to create application instances and personalize the application instances;
providing memory on the chip of the secure smart object to receive and store a data package transferred to the chip of the secure smart object from the user device; and
the personalization application including one of more sets of pre-personalization data and command sequences, for combining with the with the data received in the data package, to minimize that the amount of the data transferred in the data package.

24. A system for personalizing a secure smart object comprising:
a chip on a secure smart object including:
a non-transitory storage medium for storing computer components; and
a computerized processor for executing the computer components comprising:
a personalization application for receiving a data package transferred to the chip from a device; and
once the transfer of the data package is complete, the personalization application processing the data package to create one or more personalized application instances on the chip of the secure smart object.

25. The system of claim 24, wherein the secure smart object includes a wearable.
